(19) United States
(12) Patent Application Publication
(10) Pub. No.: US 2007/0281856 A1
(43) Pub. Date: Dec. 6, 2007

(54) Method of producing catalyst support particles and a catalyzer using the catalyst support particles

(75) Inventors: Hirokuni Sasaki, Nagoya (JP); Jun Hasegawa, Hekinan-shi (JP); Tsutomu Ishimoto, Nagoya (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/808,128

(22) Filed: Jun. 6, 2007

(30) Foreign Application Priority Data
Jun. 6, 2006 (JP) 2006-157184
Apr. 17, 2007 (JP) 2007-107890

(51) Int. Cl. B01J 23/10

(52) U.S. Cl. 502/304; 502/355

(57) ABSTRACT

Catalyst support particles and a catalyzer are produced by using γ-alumina particles or alumina precursor particles treated in advance by hydrothermal treatment in an autoclave. Performing the hydrothermal treatment improves the thermal resistance of the alumina particles because of suppressing deformation of the alumina particles when used at a high temperature such as 1000° C.

### CROSS-REFERENCE TO RELATED APPLICATION

This application is related to and claims priority from Japanese Patent Applications No. 2006-157184 filed on Jun. 6, 2006 and No. 2007-107890 filed on Apr. 17, 2007 the contents of which are hereby incorporated by reference.

### BACKGROUND OF THE INVENTION

1. Field of the Invention

The present invention relates to a method of producing catalyst support particles and also relates to a method of producing a catalyzer using the catalyst support particles.

2. Description of the Related Art

There have been known catalyzers capable of purifying poisonous components such as hydro carbon HC, carbon monoxide CO, and nitric oxide NOx in an exhaust gas discharged from an internal combustion engine mounted on a vehicle, especially a diesel engine of a diesel vehicle. Related-art techniques, for example, Japanese patent laid open publications JP 2003-80077 and JP 2002-316049 have disclosed catalyzers having noble metal particles or promote catalyst particles serving as catalyst components which are supported through metal oxide particles such as alumina Al₂O₃ and the like by a porous inorganic base material such as cordierite, where the crystal of the alumina Al₂O₃ has γ-phase or θ-phase. Through the specification, alumina Al₂O₃ of γ-phase or θ-phase will also be referred to as γ-alumina or θ-alumina, respectively.

This catalyzer has an advantage of supporting an adequate amount of catalyst components on the porous inorganic base material on metal oxide particles of a specific surface area which is larger than that of the porous inorganic base material. However, such a related-art catalyzer of the above structure includes following drawbacks.

On use of the catalyzer within a temperature range of approximate 800° C. to 1000° C., conventional γ-alumina has a poor thermal resistance when used as metal oxide particles for supporting the catalyst components. That is, γ-alumina is transferred in phase transition to θ-alumina at approximate 1000° C. According to the progress of the phase transition to θ-alumina, the specific surface area of the alumina is drastically reduced. Therefore, on using the catalyzer at a high temperature of approximately 1000° C., the catalyst components are embedded into the inside of γ-alumina and the performance of diffusing exhaust gas is prevented and thereby the catalyst function thereof is deteriorated, or the catalyst components are sintered, so that the total surface area of the catalyst components is decreased and the catalytic activity is thereby decreased.

On the other hand, in case of using θ-alumina as metal oxide particles and also of using catalyst components having a particle size of nano-meter order, although θ-alumina has a superior heat resistance capability it is preferred or necessary to use the metal oxide particles of a fine particle size in order to efficiently diffuse the catalyst components on the metal oxide particles, there is a problem of being difficult to obtain θ-alumina particles of fine-particle size. In other words, θ-alumina particles are obtained by firing γ-alumina particles at approximate 1000° C. under the atmosphere pressure. An usual firing process causes cohesion and sinters γ-alumina particles to each other, so that a size of the obtained θ-alumina particle becomes large, and the θ-alumina particles become secondary particles of a micron-order size, not become primary particles, namely, not existing in mono-dispersion state. It is therefore necessary to use a specific technique in order to form θ-alumina particles of a fine-particle size from γ-alumina particles as raw material. Thus, in the manufacturing of the catalyzer, it is required to easily produce metal oxide particles of a fine-particle size having a superior heat resistance to the high temperature of approximate 1000° C.

The above problem of the related art technique also occurs to another type of metal oxide particles having a poor heat resistance because of changing whose specific surface area at a high temperature at which the catalyzer is used, or also occurs to another type of metal oxide particles having a good heat resistance, but not having a fine particle size (or fine grain size).

### SUMMARY OF THE INVENTION

It is an object of the present invention to provide a method of producing catalyst support particles capable of supporting catalyst components on metal oxide particles, and also to provide a method of producing a catalyzer using the catalyst support particles, while suppressing increase of the size of each metal oxide particle and improving thermal resistance capability of the metal oxide particles.

To achieve the above purposes, the present invention provides a method of producing catalyst support particles in which catalyst components are supported on surfaces of metal oxide particles. The method has the following steps. Metal oxide particles dispersed in a liquid are prepared. Hydrothermal treatment for the metal oxide particles in the liquid is performed under a pressure applied to the liquid so that thermal resistance of the metal oxide particles is increased while suppressing increase of a particle size of each metal oxide particle, and supporting the catalyst components on the metal oxide particles treated by the hydrothermal treatment.

In accordance with another aspect of the present invention, there is provided a method of producing catalyst support particles in which metal oxide particles support catalyst components. The method has following steps. Metal oxide particles dispersed in a liquid are prepared. Hydrothermal treatment for the metal oxide particles in the liquid is performed under a pressure applied to the liquid so that thermal resistance of the metal oxide particles is increased while suppressing increase of a particle size of each metal oxide particle under a condition capable of decreasing a specific surface area of each metal oxide particle after firing the metal oxide particles at 800° C., when compared with those of the metal oxide particles without performing the hydrothermal treatment. The catalyst components are supported on the metal oxide particles treated by the hydrothermal treatment.

According to the present invention, the hydrothermal treatment is performed in advance for the metal oxide particles in the liquid under a specified applied pressure in order to reduce the specific surface area of the metal oxide particle which are heated at a temperature lower than the maximum temperature (for example, at 1000° C.) within a temperature range where the catalyst support particles will be used, when compared with that of the metal oxide particles without performing any hydrothermal treatment. This manner of performing the hydrothermal treatment in advance before the heating can achieve that the specific surface area of the metal oxide particle approaches to that of the metal oxide particle which is heated at the maximum temperature in the temperature range to be used. It is thereby possible to suppress a drastic decreasing of the specific surface area of the metal oxide particles caused by rising the temperature at which the catalyst support particles are used. According to the present invention, it is possible to increase the thermal resistance capability of the metal oxide particles.

Further, it is possible to easily produce the metal oxide particles of a fine particle size with a superior thermal resistance by setting the process conditions of decreasing the particle size of the metal oxide particles during the hydrothermal treatment.

The meaning of suppressing the increase of the particle size indicates that the increased amount of the particle size is suppressed rather than the increased amount of the particle size when the metal oxide particles are fired at a high temperature such as at 1000° C. under an atmosphere pressure. For example, this means that the increased particle size after the hydrothermal treatment becomes a value within not more than twice of the particle size before the hydrothermal treatment.

In a concrete example, the hydrothermal treatment is performed by setting the pH of the liquid to a specified value so that a surface voltage potential of the metal oxide particle in the liquid has a voltage potential at which the metal oxide particles can be dispersed in a mono-dispersion state. This can suppress the increase of the particle size of the metal oxide particles after performing the hydrothermal treatment.

In addition, it is possible to use one of, or a mixture of water, ethanol, and isopropanol as the liquid in the hydrothermal treatment.

Further, in order to suppress increasing of the particle size of the metal oxide particles after the hydrothermal treatment, it is preferred to perform the hydrothermal treatment by adding aqueous polymer as a dispersion agent into the liquid, which is capable of promoting the dispersion of the metal oxide particles in the liquid, where the aqueous polymer is selected from one of, or a mixture of not less than two of polyvinyl alcohol, polyethylene glycol, polyvinyl pyrrolidone, and trehalose.

Still further, when γ-alumina particles or alumina precursor particles are used as the metal oxide particles, the condition of the hydrothermal treatment is set as follows. For example, when the pH of the liquid is set to a range of 2 to 4 where water is used as the liquid, the heating temperature is set to a temperature of not less than 180° C. and not more than a temperature of suppressing cohesion of those particles to each other under an applied pressure corresponding to the heating temperature. That is, the heating temperature is set to not more than 240° C. and the applied pressure during the hydrothermal treatment is set to the vapor pressure corresponding to the heating temperature.

It is thereby possible to decrease the change of the specific surface area of the alumina particles when the heating temperature is changed from 800° C. to 1000° C., and thereby possible to increase the thermal resistance capability of the alumina particles.

According to the present invention, in case of using the catalyst support particles within a temperature range of approximate 800° C. to 1000° C., it is possible to prevent the deterioration of the catalyst function, (for example, such deterioration of the catalyst function is that the catalyst components are embedded into the inside of the alumina particles and gas diffusion is thereby prevented), even if the temperature of the catalyst support particle is changed from about 800° C. to about 1000° C.

Still further, it is preferred that the heating temperature is set to a temperature capable of decreasing the phase transition of the alumina particles from γ-phase to θ-phase, and also preferred that the hydrothermal treatment is performed under the condition so that the θ-phase of the alumina particles are obtained by firing them at 800° C. after performing the hydrothermal treatment. For example, it is preferred that the hydrothermal treatment is performed at 220° C. for 3 hours or at 240° C. for a period within a range of not less than 1 hour and not more than 3 hours. Taking those conditions during the hydrothermal treatment can avoid the occurrence of phase transition of the alumina particles in the temperature range at which the catalyst support particles are used. It is thereby possible to increase the thermal resistance capability of the alumina particles because of preventing the decreasing of the specific surface area of the alumina particles caused by the phase transition.

Still further, when the catalyst components are supported on the metal oxide particles treated by the hydrothermal treatment, the metal oxide particles are cohesively gathered to each other so that pore parts whose size is larger than the size of each catalyst component, penetrate pore parts whose size is smaller than the size of each catalyst component are generated to form the cohesive metal oxide particles, and the catalyst components are placed in the pore parts in order to fix the catalyst components to the metal oxide particles. By applying the feature of the present invention to the production of the catalyst support particles having such a configuration, it is possible to avoid the occurrence of sintering the catalyst components to each other by moving the catalyst components through the penetrate pore parts caused by deforming the shape of the metal oxide particles when the catalyst support particles are used at a high temperature.

### BRIEF DESCRIPTION OF THE DRAWINGS

A preferred, non-limiting embodiment of the present invention will be described by way of example with reference to the accompanying drawings, in which:

FIG. 1A is a schematic sectional view of a catalyzer according to a first embodiment of the present invention;

FIG. 1B is an enlarged sectional view of a coated layer in the catalyser shown in FIG. 1A;

FIG. 1C is an enlarged view of the coated layer in the catalyzer shown in FIG. 1B;

FIG. 2 is a perspective view of an apparatus to be used in a hydrothermal treatment according to the first embodiment of the present invention;

FIG. 3 is a graph showing a relationship between a surface electric potential of γ-alumina particle and pH of a liquid;

FIG. 4 is a schematic view of a catalyst component to be used in the method of producing the catalyzer according to the first embodiment;

FIG. 5 is a graph showing a relationship between the surface voltage potential of the catalyst component and the pH of a catalyst dispersing solution;

FIG. 6 is a graph showing a relationship between a firing temperature at 500° C., 800° C., and 1000° C. for 5 hours under an atmosphere pressure and a specific surface area of alumina particles without hydrothermal treatment and with hydrothermal treatment at 240° C. for 1 hour;

FIG. 7 is a graph showing X-ray diffraction results of the alumina particles after firing process at 800° C. for 5 hours, with the hydrothermal treatment under various conditions and without the hydrothermal treatment;

FIG. 8 is a schematic view of θ-alumina particles obtained by firing γ-alumina particles at 1000° C. for atmosphere pressure, as a comparative example of the first embodiment;

FIG. 9 is a schematic view of θ-alumina particles with catalyst components thereon obtained by firing γ-alumina particles at 1000° C. under atmosphere pressure, as a comparative example of the first embodiment;

FIG. 10 is a schematic view showing alumina particles after the hydrothermal treatment according to the first embodiment; and

FIG. 11 is a schematic view showing alumina particles with catalyst components thereon after the hydrothermal treatment according to the first embodiment.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Embodiment

A description will be given of a structure of a catalyzer produced by the method according to the first embodiment of the present invention with reference to diagrams.

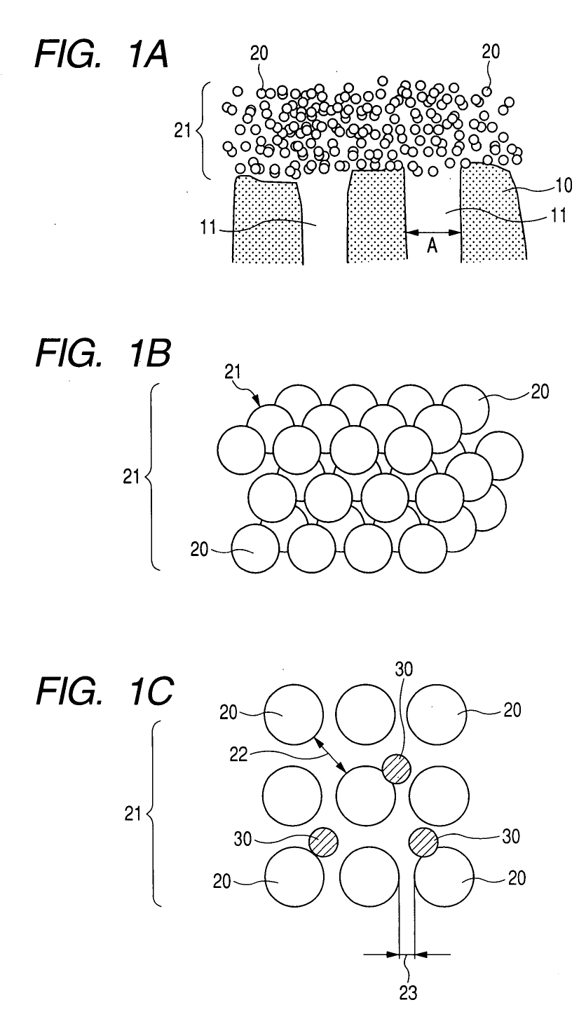

FIG. 1A is a schematic sectional view of the catalyzer according to the first embodiment of the present invention. FIG. 1B is an enlarged sectional view of a coated layer 21 in the catalyzer shown in FIG. 1A. FIG. 1C is an enlarged view of the coated layer 21 shown in FIG. 1B.

As shown in FIG. 1A, the catalyzer of the first embodiment has a structure in which the coated layer 21 is formed on the surface of a porous inorganic base material 10. The coated layer 21 is made mainly of alumina particles 20 and the like as metal oxide particles. As will be described later in detail, the alumina particles 20 to be used through the embodiments of the present invention are obtained by treating γ-alumina particles at a high temperature under a high pressure (namely, by performing a hydrothermal treatment) to γ-alumina particles placed in an autoclave.

The porous inorganic base material 10 is made of an inorganic material having a plurality of porous 11 on a surface of cordierite. The first embodiment uses monolithic cordierite of a honeycomb shape as the porous inorganic base material 10, whose average pore diameter is within a range of approximate 1 to 2 μm from the results of measurements performed by the inventors according to the present invention.

As shown in FIG. 1B, the coated layer 21 is made of the alumina particles 20 which are irregularly arranged in three dimensions. Although FIG. 1B shows the alumina particles 20, each independently separated to each other, each alumina particle 20 is contacted together here and there in the three dimensional arrangement.

As shown in FIG. 1C, the coated layer 21 is composed of the γ-alumina particles 20, pore parts 22 and penetration pore parts 23. The size of each pore part 22 is wider than that of each catalyst component 30, and on the contrary, the size of each penetration pore part 23 is narrower than that of each catalyst component 30. The penetration pore parts 22 joint the pore parts 22 together. The catalyst components 30 are placed in the pore parts 22. The catalyst components 30 are supported on the surface of the alumina particles 20. Such alumina particles 20 supporting the catalyst components 30 thereon correspond to catalyst support particles defined in claims according to the present invention. Through the embodiments of the present invention, the coated layer 21 comprises those catalyst support particles.

A concrete size of each particle and each part will now be explained as follows:

An average particle size of the alumina particles 20 is within a range of 5 to 100 μm;

An average wide of the porous parts 22 is within a range of 3 to 500 nm; and

An average wide of the penetration porous parts 23 is within a range of 0.3 to 40 nm.

For example, on using the catalyst components 30 whose average particle size is approximately 5 nm, the alumina particles 20 whose average particle size is approximately 20 nm are used. In this case, each of the accumulated alumina particles 20 has the pore part 22 whose average size is approximately 8 nm, and the penetration pore part 23 has the width of less than 5 nm. It is possible to use, as the catalyst component 30, noble metal particles such as platinum (Pt), Palladium (Pd), rhodium (Rh), and the like, or promote catalyst particles composed mainly of cerium oxide (CeO₂), or zirconia (PSZ). However, it is acceptable to use another material having the catalyst function.

As described above, the method according to the first embodiment uses the alumina particles 20 of a fine particle size of nano-meter order as the support particles capable of supporting the catalyst components.

Under the condition of a same amount of the support particles, the size of the pore part formed between adjacent support particles can be decreased and the number of the pore parts is also increased according to decreasing of the particle size of the support particle. In this case, the surface area of the pore part becomes large and the catalyst components supported on the surfaces of the pore parts are highly dispersed. According to the first embodiment of the present invention, it is possible to support the catalyst components on the support particles with a high dispersion state when compared with the support particles whose particle size is, for example, a micron-meter order, greater than a nano-meter order.

In case of the catalyst components 30 whose particle size is nano-meter order, in particular, less than 10 nm, and the support particle whose size is more than nano-meter order which is different from the first embodiment of the present invention, because the pore part 22 composed of gaps between particles is relatively large, many catalyst components 30 exist in the pore parts 22. Further, the penetrate pore part 23 which is smaller in length than the pore part 22 becomes larger than the particle size of the catalyst component 30. The catalyst components 30 easily move because of existing an adequate space in the coated layer 21 show in FIG. 1A and FIG. 1C. In this case, when the catalyzer uses under a high temperature environment, the catalyst components 30 are sintered together under a high temperature condition, and a specific surface area of the catalyst components serving the reaction activity is reduced.

On the contrary, because the first embodiment of the present invention uses the alumina particles 20 of a fine particle size as the support particles for supporting catalyst components, it is possible to form the penetrate pore part 23 between adjacent alumina particles 20 gathered together, where the width of each penetrate pore 23 is narrower than the size of each catalyst component 30.

In the construction of the coated layer 21 which is composed of the alumina particles 20 contacted with catalyst components 30, the pore parts 22, the penetrate pore part 23, it is difficult to move each catalyst component among the pore parts 22. This means that the alumina particles 20 act as blocking agent or material capable of preventing the movement of the catalyst components 30 between the pore parts 22. Even if the catalyzer is used under high temperature and high pressure conditions, it is thereby possible to suppress the occurrence of sintering the catalyst components 30.

Next, a description will now be given of the method of producing the catalyst support particles and the catalyzer, according to the first embodiment of the present invention, by using the catalyst components 30 whose average particle size is approximately 5 nm.

First, γ-alumina particles are prepared, which do not support any catalyst components 30 and whose average particle size is approximately 20 nm. The γ-alumina particles are treated under a high temperature and a high pressure in an autoclave 40 (namely, by hydrothermal treatment).

In the hydrothermal treatment, the γ-alumina particles are heated in a liquid under a high pressure to be applied so that the physical characteristics of the γ-alumina particles, in particular, the specific surface area thereof is approached to that of θ-alumina particle while suppressing the increase of the particle size of the γ-alumina particle.

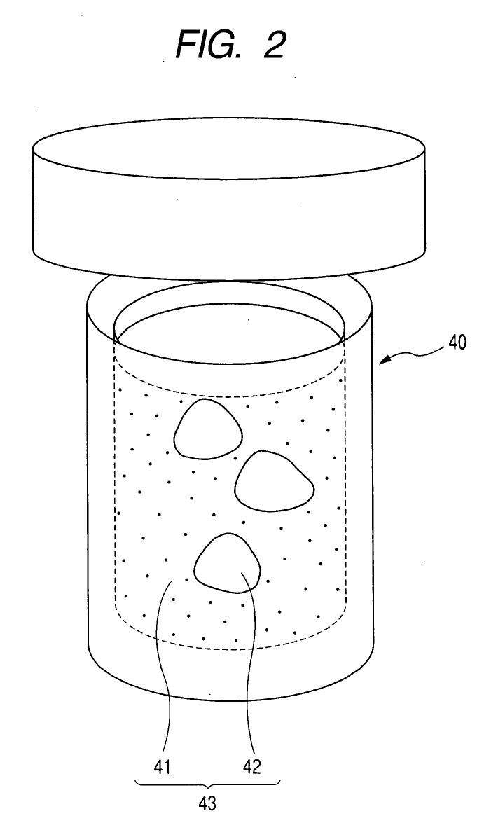

FIG. 2 is a perspective view of the autoclave 40. For example, the autoclave 40 is capable of making a high pressure therein, and made of stainless steel and closed completely without any leakage. In a concrete example, as shown in FIG. 2, alumina sol is placed in the autoclave 40. The autoclave 40 is then completely closed without any leakage. The alumina sol 43 is composed of the γ-alumina particles 42 dispersed in a liquid 41. At this time, the pH of the liquid 41 is so set that a surface voltage potential of the γ-alumina particle in the liquid 41 becomes a voltage potential at which the γ-alumina particle 42 is dispersed in the liquid 41 as a primary particle.

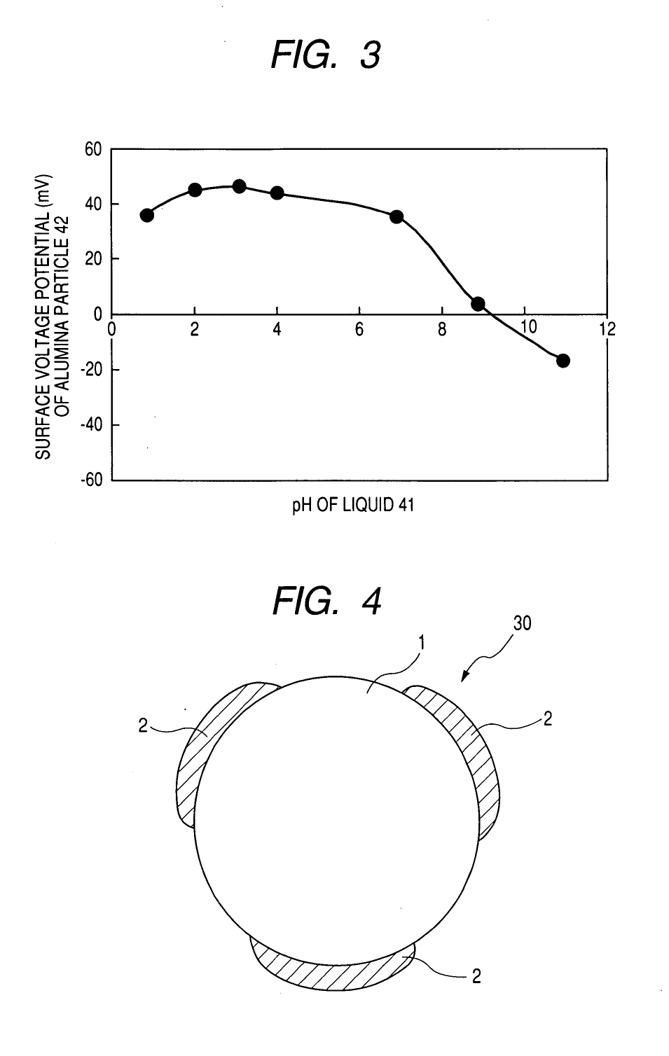

FIG. 3 is a graph showing measurement results of a surface electric potential (zeta voltage potential) of the γ-alumina particle measured by using ELS-8000 made by OTSUKA ELECTRONICS CO., LTD.

The dispersion state of particles in a liquid is determined whether or not the particles are dispersed in mono-particle state under the balance between an electrostatic repulsive force and Van der waals force between particles. When the electrostatic repulsive force is greater than Van der waals force, the particles exist as the primary particles in mono-dispersion state. On the contrary, when the electrostatic repulsive force is smaller than Van der waals force, the particles are gathered together as the secondary particles, not in the mono-dispersion state.

As shown in FIG. 3, the surface voltage potential (zeta voltage potential) of the γ-alumina particle is higher than +30 mV when pH is within a range of 1 to 7 (pH=1 to 7). In particular, when pH is within a range of 2 to 4 (pH=2 to 4), the surface voltage potential (zeta voltage potential) of the γ-alumina particle is approximately +40 mV as the maximum voltage potential. Accordingly, in order to obtain the electrostatic repulsive force by which the γ-alumina particles 42 can be dispersed as the primary particles in the mono-dispersion state in the liquid 41, for example the pH of the liquid 41 is so set within a range of 1 to 7. In the embodiments as described later, the pH of the liquid 41 is set within a range of 2 to 4 on considering the surface voltage potential of the catalyst component 30.

In a concrete example, the alumina sol 43 is used, in which the γ-alumina particle 42 are dispersed in the liquid 41 whose pH is adjusted within a range of 2 to 4 made by adding nitride acid into pure water. For example, it is possible to use Alumina sol 520 manufactured by NISSAN CHEMICAL INDUSTRIES, LTD and made of water as a dispersion solvent, colloidal alumina of boehmite plate-shaped crystal of stable nitric acid type, the average size of γ-alumina particle of 20 nm, and alumina particle concentration of 20 wt %. The pH of Alumina sol 520 is adjusted within a range of 3 to 4.

The dispersion agent is added into the liquid 41 in order to efficiently disperse the γ-alumina particles 42 therein. It is possible to use aqueous polymer as the dispersion agent, such as one or a mixture of polyvinyl alcohol, polyethylene glycol (PEG), polyvinyl pyrrolidone (PVP), and trehalose.

The γ-alumina particles 42 dispersed in the liquid 41 in the autoclave 40 is then heated. It is so set that the heating temperature to heat the autoclave 40 is higher than a room temperature and lower than the temperature at which the γ-alumina particle is changed in phase transition from γ-phase to θ-phase under the atmosphere pressure, and lower the temperature capable of suppressing any increase of the particle size of the γ-alumina particle. The concrete example of the heating temperature is within a range of 180 to 240 and the heating period is within a range of 1 to 3 hours.

In case of the hydrothermal treatment for the γ-alumina particles 42 dispersed in the liquid 41 in the autoclave 40 as a closed vessel, the high pressure state made by the vapor pressure of the liquid 41 is applied to the γ-alumina particles 42. For example, when the liquid 41 is water, the vapor pressure of water can be obtained at the temperature of not less than 100° C. The high pressure of approximate 4 MPa is applied to the γ-alumina particles 42 at the temperature of 240° C. The total volume of the liquid 41 is not decreased even if it evaporates, and the γ-alumina particles 43 exist with an initial dispersing concentration in the liquid 41, and the pH of the liquid 41 is not changed because the autoclave 40 is completely sealed.

After the completion of the hydrothermal treatment, the alumina particles 42 exists in a crystal phase other than γ-phase and θ-phase, and the particle size thereof is not increased, that is, the increase of the particle size of the γ-alumina particle is suppressed during the hydrothermal treatment. For example, after the hydrothermal treatment of the first embodiment, the average particle size (as primary particle size) of the alumina particle 42 is approximately 29 nm.

After performing the hydrothermal treatment for the γ-alumina particles 42 by heating the inside of the autoclave 40, the inside of the autoclave 40 is cooled.

In addition to the hydrothermal treatment to the γ-alumina particles 42, the catalyst dispersed solution is prepared, in which the catalyst components 30 are dispersed in a solvent.

FIG. 4 is a schematic view of the catalyst components 30 to be used for producing the catalyzer according to the first embodiment.

In the embodiment of the present invention, as shown in FIG. 4, as the catalyst component 30, a catalyst particle having a high activation and capable of activating plural materials is used. Such a catalyst particle is composed of a base particle 1 and a surface coating layer 2 which covers at least a part of the surface of the base particle 1, where the base particle 1 is one kind of mono-material fine particle or solid solution fine particle composed of two or more kinds of the mono-material having a primary particle size of a nanometer order, and the surface coating layer 2 made of one or more kind of metals or derivatives thereof.

The primary particle size of the base particle 1 is a diameter of a single base particle 1, and the nano-order primary particle size is not more than 100 nm. In the embodiments of the present invention, the base particle 1 has a primary particle size within a range of 3 to 10 nm. One kind of mono-material (or uni-material) fine particle is a fine particle composed of ceramic and a metal element or compound thereof. The solid solution fine particles composed of two or more kinds of the single material is a fine particle where two or more ceramic and metal elements or compounds thereof are in a solid solution. The present invention does not limit the characteristics and the composition ratio of two or more the solid solutions. In order to enhance the purifying performance such as the temperature characteristic and durability of the catalyzer produced, it is possible to freely adjust those characteristics and the composition ratio of two or more the solid solutions.

The base particle 1 is made of one of metal oxide, metal carbide, and carbon material. The metal oxide is one kind of mono material selected from among oxides of Ce, Zr, Al, Ti, Si, Mg, W and Sr and derivatives thereof, or solid solution composed of two or more kinds of the mono materials. SiC or derivative thereof can be used as the metal carbide. Graphite can be used as the carbon material. The base particle 1 of nano-order fine particle can be produced by coprecipitation method, sol-gel method, and plating method.

As one or more kinds of metals or derivatives thereof forming the surface coating layer 2, one or more kinds of mono materials of, or a solid solution composed of two or more kinds of noble metals having catalyst capability such as Pt, Rh, Pd, Au, Ag and Ru and oxides thereof can be used.

In a concrete example, the base particle 1 with the surface coating layer 2 is prepared, where the average particle size thereof is within a range of 3 to 10 nm, the base particle 1 is composed of a solid solution made of metal oxides of Ce and Zr, and the surface covering layer 2 is made of Pt. In order to make the catalyst dispersing solution, the catalyst component 30 is dispersed in a solution whose pH is set to a value within a range of 2 to 4, preferably, 3 which is made by adding nitric acid into pure water.

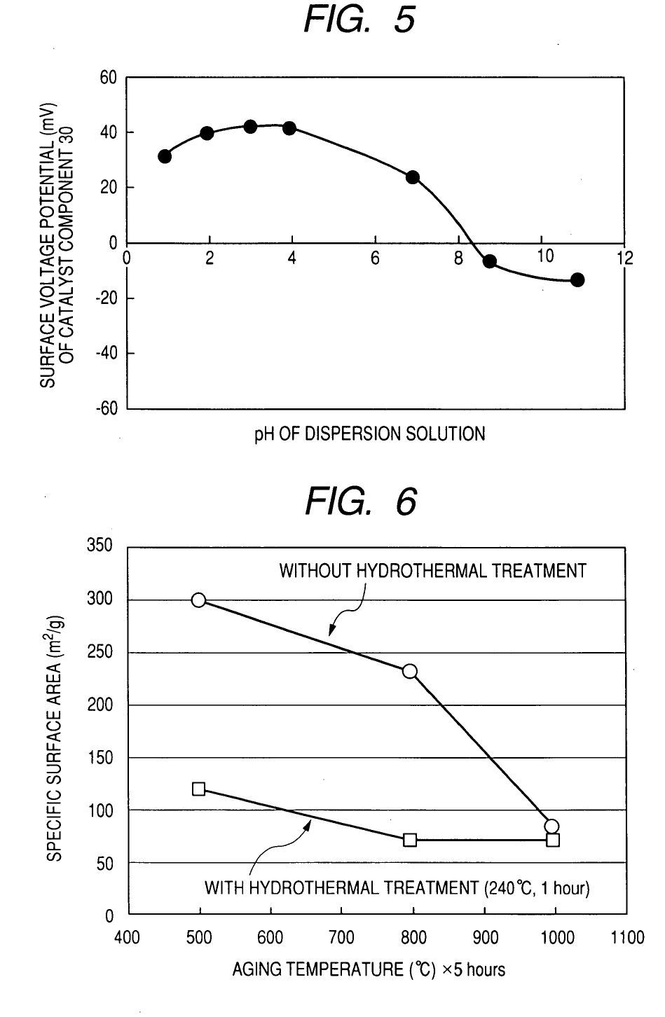

FIG. 5 is a graph showing a relationship between the surface voltage potential of the catalyst component 30 and pH of the catalyst dispersing solution. As shown in FIG. 5, the surface voltage potential of the catalyst component 30 takes approximately 40 mV when the pH of the dispersing solution is within a range of 2 to 4, in particular, it has the maximum voltage potential when the pH of the dispersing solution is 3. It is therefore possible to have the mono-dispersion of the catalyst components 30 in pure water by adjusting the pH of the dispersing solution.

Following, the catalyst dispersing solution prepared and the alumina sol 43 obtained from the autoclave 40 after the completion of the hydrothermal treatment are mixed in order to make the mixed dispersion solution of the catalyst components 30 and the alumina particles.

When the pH of the mixed dispersion solution of the catalyst components 30 and the alumina particles is within a range of 2 to 4, the catalyst components 30 and the alumina particles are independently dispersed to each other in the solution without cohesion and any contact because each of the catalyst components 30 and the alumina particles has an approximate same surface voltage potential, and those primary particles are not thereby gathered and repulsed to each other with a high dispersion state, as shown in FIG. 3 and FIG. 5.

For example, the catalyst components 30 and the alumina particles are highly dispersed in pure water of pH 3 by mixing following two dispersion solutions, one dispersion solution involves the catalyst components which are dispersed as the mono dispersion state in pure water whose pH is 3 by adding nitride acid and the concentration of the catalyst components is within a range of 5 to 15 wt %, and the other dispersion solution involves the alumina particles, whose concentration is 20%, dispersed as mono dispersion state in pure water of pH 3.

By drying the mixed dispersion solution after mixing the mixed dispersion solution for 30 minutes or more, the mixture powder composed of the alumina particles 20, the pore parts 22, the penetrate pore parts 23, and the catalyst components 30 embedded in the pore parts 22 can be obtained, as shown in FIG. 1C. The mixture powder is finally fired under a firing condition such as at 800° C. for 5 hours.

In the production of such a mixture powder, for example, the mixed dispersion solution is concentrated and dried at 70° C. under a reduced pressure by using a rotary evaporator, and the dried one is then crushed in an automatic mortar into powder of secondary particles whose particle size is approximately within a range of 0.1 to 20 μm. In order to concentrate and dried the mixed dispersion solution, it is also acceptable to use another means such as a spray dryer instead of the rotary evaporator. On using the spray dryer, it is possible to obtain the secondary particles of a desired particle size by adjusting a nozzle diameter of the spray dryer. Accordingly, the use of the spray dryer can eliminate any automatic mortar.

By using the manner described above, it is possible to produce the catalyst support particles in which the alumina particles are fixed together and the alumina particles and the catalyst components are fixed together.

Following the above processes, the catalyst support particles of power are dispersed in a solution in order to make a dispersion solution, and the dispersion solution made is applied onto the surface of the porous inorganic base material 10. The porous inorganic base material 10 with the dispersion solution is then dried and fired. The catalyst support particles are thereby coated on the surface of the porous inorganic base material. The above manner produces the catalyzer according to the first embodiment of the present invention, in which the coated layer 21 is formed on the surface of the porous inorganic base material 10, and the coated layer 21 is composed of the pore parts 22, the penetration pore parts 23, and the catalyst components embedded in the pore parts 22.

Next, a description will now be given of the main features of the catalyst support particle and the catalyzer according to the first embodiment of the present invention.

In the production of the catalyst support particles using γ-alumina particles according to the first embodiment, the hydrothermal treatment by the autoclave is performed before supporting the catalyst components 30 on the alumina particles, where the heating temperature in the hydrothermal treatment is within a range of 180 to 240° C., and the heating period is within a range of 1 to 3 hours.

As can be understood from following experimental results shown in Table 1 and Table 2, the manner of the first embodiment can suppress the occurrence of deformation of the alumina particle when firing the alumina particles at 800° C. and further firing those particles at 1000° C. while suppressing increase of its particle size. That is, it is possible for the method of the first embodiment to produce the alumina particles with improved thermal resistance.

The alumina particles produced under various conditions described above were fired under atmosphere pressure at 800° C. for 5 hours, at 950° C. for 5 hours, and at 1000° C. for 5 hours. In particular, Table 1 shows the experimental results of the specific surface areas of the alumina particles which were fired at 800° C. for 5 hours and at 1000° C. for 5 hours. Through the experiment, “Alumina sol 520” (manufactured by NISSAN CHEMICAL INDUSTRIES, LTD) was used as alumina sol, and the hydrothermal treatment was performed with the rising time of 15 minutes from room temperature to each target temperature (800° C., 950° C., and 1000° C.), and each target temperature was kept within a range of 1 to 3 hours. In this case, the alumina particles did not support any catalyst component.

Table 1 further shows the specific surface areas of comparative examples such as non-treated γ-alumina particles and θ-alumina particles commercially available (such as AKP-G008 manufactured by SUMITOMO CHEMICAL Co,. Ltd) which were fired at 800° C. for 5 hours and at 1000° C. for 5 hours.

AUTOSORB-1 produced by YUASA-IONICS COMPANY, LIMITED was used as measurement apparatus for measuring the specific surface area of each sample.

By the way, Table 1 shows several cases in which the specific surface area of the alumina particle after firing process at 1000° C. is higher than that after firing process at 800° C. Because such cases were caused by measurement error without any decreasing of the specific surface area of the alumina particle, the decreasing amount of the specific surface area of the alumina particle for each case is designated with zero in Table 1.

TABLE 1

| Conditions of | | | | | |
|---|---|---|---|---|---|
| Hydrothermal treatment | | | | | Reduction amount |
| Tem. | Pressure | Hours | Surface area (m²/g) | | of specific surface area |
| (° C.) | (MPa) | (hrs) | 800° C., 5 hours | 1000° C., 5 hours | from 800° C. to 1000° C. |
| none | none | none | 233.4 | 82 | 151.4 |
| 150 | | 1 | 237.3 | not measured | |
| 180 | 1 | 1 | 179.3 | 79 | 100.3 |
| 200 | 1.9 | 1 | 130.1 | 78 | 52.1 |
| 220 | 2.3 | 1 | 117 | 91 | 26 |
| 220 | 2.3 | 3 | 77.3 | 81.5 | 0 |
| 240 | 4.2 | 1 | 73.9 | 71 | 2.9 |
| 240 | 4.2 | 3 | 46 | 51.2 | 0 |
| 240 | 4.2 | 5 | 46.1 | 44.2 | 1.9 |
| 280 | 6.4 | 1 | 46 | 44.2 | 1.8 |
| 330 | 13.2 | 1 | 52.8 | 57.4 | 0 |
| 390 | 28.8 | 1 | 45.3 | 44.2 | 1.1 |

| | | | |
|---|---|---|---|
| θ - alumina | 65.6 | 66.8 | 0 |
| (AKP-G008)*⁾ | | | |

*⁾AKP-G008 manufactured by SUMITOMO CHEMICAL Co,. Ltd)

As shown in Table 1, because the alumina particles without performing the hydrothermal treatment have a large specific surface area after firing process at 800° C., it takes a large decreased amount of the specific surface area, approximate 151 m²/g after firing process at 1000° C. which was further performed after the above firing process at 800° C.

On the contrary, the alumina particles which was treated in advance at 180° C. by the hydrothermal treatment have a relatively small specific surface area, approximate 179 m²/g after firing process at 800° C., this case has a small decreased amount of the specific surface area, approximate 100 m²/g after firing process at 1000° C. which was performed after firing process at 800° C. That is, according to the increase of the processing temperature from the initiating temperature of 180° C. in the hydrothermal treatment, the decreased amount of the specific surface area of the alumina particles after firing process at 1000° C. which was performed after firing process at 800° C. is further decreased. In case of taking a constant processing temperature, there is a tendency that a long period of heating process in the hydrothermal treatment can further decrease the specific surface area of the alumina particles after performing the firing process at 800° C.

FIG. 6 is a graph showing the relationship between the firing temperatures of 500° C., 800° C., and 1000° C. for 5 hours and the specific surface area of the alumina particles which were without hydrothermal treatment and with hydrothermal treatment at 240° C. for 1 hour.

As can be understood from FIG. 6, it is possible to approach the specific surface area of the alumina particles after firing process at 500° C., 800° C., rather than 1000° C. to the specific surface area of the alumina particles after firing process at 1000° C. when hydrothermal treatment was performed for γ-alumina particles as the alumina particles. Because the alumina particles which were fired at 1000° C. after firing process at 800° C. has a small variation or change of its specific surface area, this condition can suppress the deformation of the alumina particles. This indicates that the thermal resistance performance of the alumina particle with the hydrothermal treatment can be improved and enhanced.

In particular, the processing conditions of the hydrothermal treatment, at 220° C. for 3 hours, at 240° C. for 1 hour, at 240° C. for 3 hours, at 240° C. for 5 hours, at 280° C. for 1 hour, at 330° C. for 1 hour, at 390° C. for 1 hour take approximate same values of the absolute specific surface areas after both firing processes at 800° C. and 1000° C., and of the reduced amount of the specific surface areas of the alumina particles after firing process 1000° C. which was performed after firing process at 800° C., when compared with the case of commercially available θ-alumina particles (AKP-G008 manufactured by SUMITOMO CHEMICAL Co,. Ltd).

From the experimental results described above, it can be considered that the alumina particles treated by the hydrothermal treatment can adequately keep the same thermal resistance capability which is approximately equal to that of the θ-alumina particles. The reason that the hydrothermal treatment under the process conditions at 220° C. for 3 hours and at 240° C. for a range of 1 to 3 hours provides a superior thermal resistance capability of the alumina particles can be explained based on a changing mechanism of crystallization of the alumina particles.

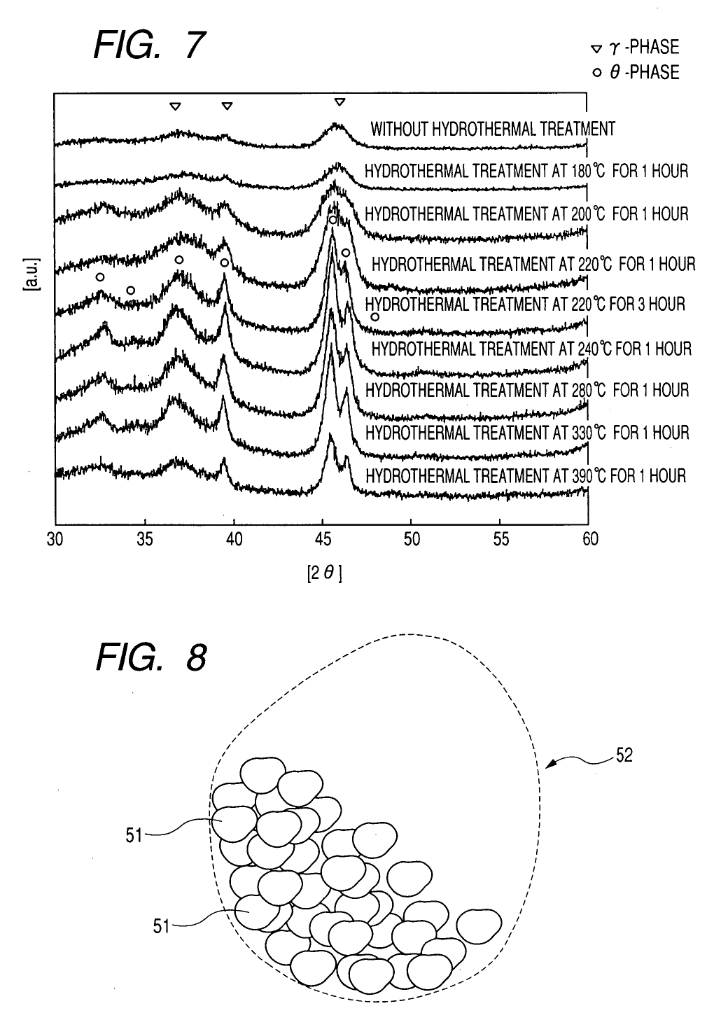

FIG. 7 is a graph showing X-ray diffraction results of the alumina particles after firing process at 800° C. for 5 hours, which are of non-hydrothermal treatment and of the hydrothermal treatment under various conditions. RINT2000 produced by RIGAKU Corporation was used in the Xray-diffraction measurement.

As shown in FIG. 7, the crystal phase of the alumina particles after firing process at 800° C. for 5 hours becomes γ-phase, where those alumina particles were not treated by hydrothermal treatment and treated by hydrothermal treatment at 180° C. for 1 hour, at 200° C. for 1 hour, and at 220° C. for 1 hour.

On the contrary, the crystal phase of the alumina particles after firing process at 800° C. for 5 hours became θ-phase of a superior thermal resistance when the alumina particles were treated by the hydrothermal treatment at 220° C. for 3 hour, at 240° C. for 1 hour, at 280° C. for 1 hour, at 330° C. for 1 hour, and at 390° C. for 1 hour.

Similar to the measurement results of the alumina particles obtained by X-ray diffraction described above, it is recognized from the results of measurement performed by Electron diffraction that there are difference in crystal phase after firing process 800° C. for 5 hours between the alumina particles without hydrothermal treatment and the alumina particles with hydrothermal treatment at 390° C. for 1 hour.

From considering the experimental results described above, it is possible to obtain the alumina particles of θ-phase having a superior thermal resistance capability after firing process at 800° C. for 5 hours when the hydrothermal treatment at 220° C. for 3 hours and at more than 240° C. is performed to the alumina particles. That is, in general, the phase-transition temperature of the alumina particles from γ-phase to θ-phase is approximately 1000° C. and θ-alumina particles are stable at 1000° C. or more. However, it can be understood from the above experimental results that the phase-transition temperature of the alumina particles from γ-phase to θ-phase is decreased from approximate 1000° C. to 800° C. or below by performing the hydrothermal treatment.

As described above in detail, because the alumina particles after performing the hydrothermal treatment at 220° C. for 3 hour and at more than 240° C. have already become θ-phase after firing process at 800° C., even if those alumina particles is fired at 1000° C. for 5 hours under atmosphere pressure, the phase transition of each alumina particle does not occur and the specific surface area of each alumina particle is not reduced.

On the contrary, because the alumina particles without hydrothermal treatment and with the hydrothermal treatment at 180° C. for 1 hour, at 200° C. for 1 hour, and at 220° C. for 1 hour are changed in phase from γ-phase to θ-phase by performing firing process at 1000° C. for 5 hours under atmosphere pressure, this indicates that the specific surface area of each alumina particle is greatly decreased when compared with the alumina particles with the hydrothermal treatment at 220° C. for 3 hours and at not less than 240° C.

The X-ray diffraction results do not show any peak values of both γ-phase and θ-phase of the alumina particles following the hydrothermal treatment before firing process. This means that the alumina particles are changed to γ-phase and θ-phase only after firing process at 800° C.

Table 2 shows the measurement results of a particle size of the alumina particle obtained after the hydrothermal treatment under various conditions. The particle size of the alumina particles in a dispersion solution were measured by Dynamic Light Scattering Nanoparticle Size Analyzer LB-550 (produced by HORIBA, Ltd). Although LB-550 did not measure the particle sizes of the alumina particles under cohesion state in the dispersion solution, they were measured by Scanning electron microscope (SEM) or Transmission Electron Microscope (TEM).

TABLE 2

| Conditions of Hydrothermal | | | | |
|---|---|---|---|---|
| treatment | | | Particle size after Hydrothermal treatment | |
| Temp. | Pressure | Period | Average size | |
| (° C.) | (MPa) | (hr) | (nm) | State |
| none | none | none | 20 ± 6 | Mono-dispersion state |
| 180 | 1.0 | 1 | 20 ± 6 | in solution |
| 200 | 1.9 | 1 | 20 ± 6 | |
| 220 | 2.3 | 1 | 20 ± 6 | |
| 220 | 2.3 | 3 | 25 ± 6 | |
| 240 | 4.2 | 1 | 22 ± 6 | |
| 240 | 4.2 | 3 | 29 ± 6 | |
| 240 | 4.2 | 5 | 53 ± 6 | |
| 280 | 6.4 | 1 | 60˜100 | Cohesion state in |
| 330 | 13.2 | 1 | 80˜200 | solution |
| 390 | 28.8 | 1 | 100˜1000 | |

As can be understood from the cases of the hydrothermal treatment for 1 hour shown in Table 2, the alumina particles after the hydrothermal treatment of the heating temperature within a range from 180° C. to 240° C. are dispersed under mono-dispersion state in the solution, and the particle size of the alumina particles is not changed when compared with the particle size of the alumina particles before the hydrothermal treatment, and the increase of the particle size is suppressed.

On the contrary, the alumina particles after the completion of the hydrothermal treatment of not less than 280° C. do not exist in mono dispersion state, exits in cohesion state and are precipitated at the bottom of a container. In those cases, the particle size of the alumina particle in the cohesion state is approximately twice or more of each alumina particle size. Accordingly, the particle size of the alumina particles is increased when the heating temperature is higher than 280° C. during the hydrothermal treatment.

Further, in cases of the heating temperature of 220° C. and 240° C., the change of the heating period from 1 hour to 3 hours slightly increases the particle size of the alumina particles. In particular, when the hydrothermal treatment is performed at 240° C. for 5 hours, the particle size of each alumina particle exceeds twice of that of the alumina particle before the hydrothermal treatment.

By the way, it is possible to highly disperse both of the catalyst components 30 and the alumina particles 42 in the solution so long as the alumina particles 42 whose particle size is approximately 20 nm are dispersed in a mono-dispersion state in the solution. That is, because the particle size of the alumina particles is proportion to the gaps 22 and 23 between the alumina particles, the particle size of the alumina particles is decreased according to decreasing the gap between the alumina particles (see FIG. 1C). Therefore, when the particle size of the catalyst components 30 is approximately equal to the gap between the alumina particles, there is a highly possibility of existing one catalyst component 30 between the adjacent alumina particles. This state indicates the “high dispersion state”.

On the contrary, the gap between the alumina particles is increased according to increasing the particle size of the alumina particles. In this case, because plural catalyst components exist in the gap between the adjacent alumina particles, the alumina particles and the catalyst components are dispersed in low dispersion state. This indicates that it is necessary to use the alumina particles whose average particle size is not more than 40 nm when the catalyst components 30 whose average particle size is not more than 10 nm are used in order to produce the catalyst support particles having the configuration shown in FIG. 1C.

It can be considered from the experimental results shown in Table 2 that the upper limit of the heating temperature in the hydrothermal process is 240° C. for maximum 3 hours in order to suppress increasing the particle size of the alumina particles by not more than twice,

Next, a description will now be given of the reason why the particle size of the alumina particles is not increased under the heating temperature within a range of 180° C. to 240° C. and the heating period which is within a range of 1 to 3 hours.

As has been prescribed in the first embodiment of the present invention, the alumina particles are treated in advance by the hydrothermal treatment with the solution 41 whose pH is within a range of 2 to 4 (see FIG. 3) so that the surface voltage potential of each alumina particle dispersed in the solution 41 becomes a voltage potential so that the alumina particles 42 are dispersed in mono-dispersion state in the solution 41. In this case, the opportunity of contacting the alumina particles to each other in the mono-dispersion state in the solution 41 can be reduced. On the contrary, in the solution whose pH is within a range of 7 to 10 where the surface voltage potential of each alumina particle is within a range of +20 mV to −10 mV, the mono-dispersion state of the alumina particles does not occur in the liquid (or in the solution), and the alumina particles in the cohesion state are contacted to each other, and the particle size of the alumina particles therefore is easily increased.

In the first embodiment, because by the hydrothermal treatment for the alumina particles is performed in the solution in which the dispersed agent is added in the solution 41, this condition can suppress the increase of the particle size of the alumina particles 42.

As described above in detail, because the manner of the first embodiment of the present invention can increase the thermal resistance capability of the alumina particles while suppressing the increase of the particle size of the alumina particles, the first embodiment can provide the following effects.

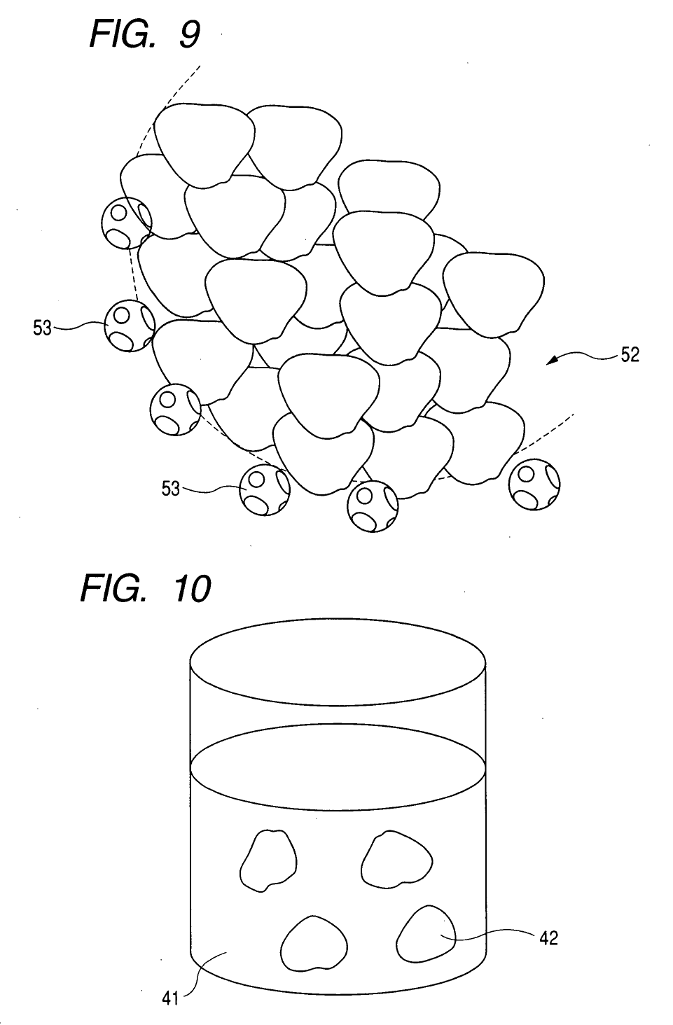

FIG. 8 is a schematic view showing the θ-alumina particles obtained by firing γ-alumina particles at 1000° C. under the atmosphere pressure. FIG. 9 is a schematic view showing the θ-alumina particles supporting catalyst components.

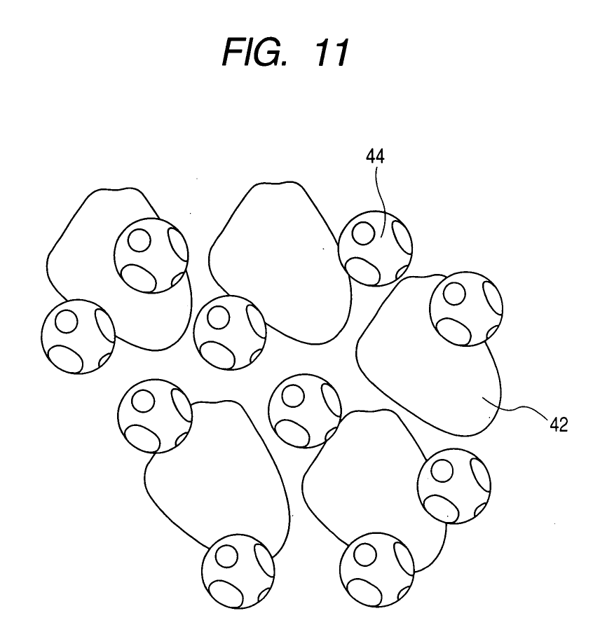

FIG. 10 is a schematic view showing the alumina particles after the hydrothermal treatment. FIG. 11 is a schematic view showing the alumina particles supporting the catalyst components.

As different from the alumina particles according to the first embodiment of the present invention, when the alumina particles after firing γ-alumina particles at 1000° C. under the atmosphere pressure, the alumina particles 51 cohere to each other and thereby form a cohesive powder of a large size as shown in FIG. 8, and those alumina particles are hardly to keep a fine particle size. It can be estimated that such a cohesive state can be considered as increasing the particle size of the alumina particles. Through the description, the cohesive state of the alumina particles is obtained by firing or sintering the alumina particles in addition to the physical bonding of the alumina particles.

As shown in FIG. 9, it is impossible to support a large amount of the catalyst components 53 on the alumina particles obtained by firing γ-alumina particles at 1000° C. under atmosphere pressure because the specific surface area of such γ-alumina particles is small and the particle size thereof is large, and the catalyst component does not reach into the inside of the gap between the adjacent alumina particles, and the catalyst components are thereby placed on the surface of the alumina particles.

On the contrary, in case of performing hydrothermal treatment to γ-alumina particles, because the alumina particles 42 are dispersed in the solution 41 shown in FIG. 10 and the particle size thereof is not changed as shown in FIG. 11, it is possible to support a large amount of the catalyst components 44 on the alumina particles 42 after the hydrothermal treatment.

When the catalyzer having the configuration shown in FIG. 1 produced from conventional γ-alumina particles is used at approximate 1000° C. for a long period, the deformation of the alumina particles such as the increase of the particle size thereof progresses by shifting γ-alumina particles to θ-alumina particles. In this case, the catalyst components are embedded in the alumina particles by the deformation of the alumina particles, and the deformation of the alumina particles deteriorates the catalyst function capable of purifying an exhaust gas and obstructs or blocks the gas diffusion.

The catalyzer having the configuration shown in FIG. 1C, as described above, because the alumina particles 20 themselves act as blocking agent for preventing or blocking moving of the catalyst components 30 between the pore parts 22, even if the catalyzer is used under a high temperature, it is possible to suppress the sintering of the catalyst components 30 to each other on condition that the alumina particles have a high thermal resistance. However, because the γ-alumina particles having the conventional configuration has a poor thermal resistance, when the catalyzer having the configuration shown in FIG. 1C is used under a high temperature condition, the penetration pore is enlarged by deforming the shape of the alumina particles, and the catalyst components are thereby moved, and the alumina particles do not act as blocking agent. In this case, the specific surface area of the catalyst components which are activated in reaction is reduced.

On the contrary, according to the catalyzer of the first embodiment, because the catalyst support particles and the catalyzer are produced by using the alumina particles after hydrothermal treatment under the prescribed conditions, when compared with the conventional case, it is possible to prevent that the catalyst components are embedded into the alumina particles even if the catalyzer is used at approximate 1000° C. for a long period. It is thereby possible that the alumina particles can act adequately as blocking agent, when compared with the catalyzer having the configuration shown in FIG. 1C.

According to the method of producing the catalyzer of the first embodiment of the present invention, it is possible to enhance the purifying capability of the catalyzer by increasing the thermal resistance of the alumina particles.

Hereinafter, a description will now be given of the results of the evaluation test of the purifying function of the catalyzer according to the first embodiment. In the method of producing the catalyzer, Alimina sol 520 was used and, the hydrothermal treatment was performed at 240° C. under the pressure of 4.2 MPa for 1 hour, and monolithic cordierite (4 mil #400, φ 30×L50) was used as the porous inorganic base material. The produced catalyzer is processed by 1/10 size of an actual monolithic body in order to use it as testing pieces.

In the evaluation test, a dummy mixed gas composed of exhaust gas components was supplied from a gas cylinder (or a gas bomb) to the catalyzer, and the atmosphere temperature (such as the test piece and the gas temperature) was increased, and T50 test was performed. T50 test determined the temperature at which the purifying rate reaches 50%.

It may be said that the lower the temperature reaching to 50%, the higher the catalyst activity and purifying performance of the catalyzer.

In the evaluation test, the temperature was gradually increased by 10° C./min during the temperature range within a range of 50 to 400° C./minutes, and the dummy exhaust gas was composed of CO, CO₂, NO, O₂, C₃H₈, C₃H₆ and N₂, and the supply amount of the dummy exhaust gas was SV (space velocity)=45000 hour⁻¹, and A/F (air-Fuel) rate, namely, Stoichiometric mixture (abbreviated to “stoich”) is set to 14.68.

After considering the environment in order to test the catalyzer, the testing pieces were treated at 800° C. for 5 hours or at 900° C. for 5 hours under the atmosphere pressure, and the purifying performance of the testing pieces after the hydrothermal treatment were performed. The results of the evaluation test indicate that the catalyzer as the testing pieces treated by the hydrothermal treatment under both the conditions, at 800° C. for 5 hours and at 900° C. for 5 hours, according to the first embodiment have improved the purifying performance thereof because the average temperature of THC, CO, NO was decreased, when compared with the catalyzer as the comparative example without any hydrothermal treatment.

### Other Embodiments

(1) The first embodiment uses γ-alumina particles as the metal oxide particles capable of supporting the catalyst components. The present invention is not limited by the first embodiment, for example, it is possible to use alumina precursor particles such as boehmite particles and the like instead of γ-alumina particles. Such alumina precursor particles are changed to alumina particles by performing the thermal treatment.
(2) In the method of producing the catalyst support particles according to the first embodiment described above, the commercially available alumina sol is used and treated by the hydrothermal treatment. It is acceptable to produce the alumina particles themselves by using raw materials. Further, although the first embodiment uses water, in particular, uses pure water as the liquid 41 (or solution) in which the alumina particles 42 are dispersed, it is possible to use another solvent instead of water.

Table 3 shows the hydrothermal treatment conditions and the evaluation results using various solvents and the alumina particles. The manner of the hydrothermal treatment and the evaluation manner are the same of those in the first embodiment.

TABLE 3

| | | Condition of | | | | |
|---|---|---|---|---|---|---|
| | | Hydrothermal treatment | | | Specific surface area | |
| | | Tem. | Pressure | Period | (m²/g) of particles | |
| Solvents | Particles | (° C.) | (MPa) | (hr) | 800° C., 5 hrs. | 1000° C., 5 hrs. |
| Water solution of | 1) | 150 | 1.1 | 1 | 157 | 118.4 |
| isopropanol 50% | | 210 | 4.1 | 1 | 119.4 | 95.9 |
| Water solution of | 1) | 210 | 3.9 | 1 | 134 | 87.9 |
| ethanol 50% and | | | | | | |
| isopropanol 25% | | | | | | |
| Water solution of | 2) | 210 | 3.8 | 1 | 103.8 | 94.8 |
| ethanol 50% | | | | | | |

1) Aluminum precursor (aluminum hydroxide) after hydrolysis of aluminum isopropoxide,
2) Alumina sol 520 manufactured by NISSAN CHEMICAL INDUSTRIES, LTD.

As shown in Table 3, in order to produce the alumina particles from raw materials, for example, there is a method of solving a specified amount of aluminum isopropoxide into pure water, and hydrolysis for the solution is then performed at 80° C. for 24 hours while refluxing the solution. This manner can synthesize the alumina particles as alumina precursor. After this process, the addition of nitric acid into the dispersed solution sets its pH to within a range of 2 to 4. This manner produces the dispersion solution of the alumina particles in which they are dispersed in mono-dispersion state. In the dispersion solution, aluminum hydroxide is dispersed in water solution of isopropanol of 50% as a solvent after hydrolysis of aluminum isopropoxide. After producing the alumina dispersing solution, the same processes of the first embodiment described above can be performed.

Because water solution of isopropanol 50% has a different vapor pressure, when compared with using pure water as a solvent, the thermal resistance of the alumina particles after the hydrothermal treatment is slightly improved. That is, on using pure water as the solvent and when the hydrothermal treatment is performed at not less than 180° C., the amount of decreasing the specific surface area of the alumina particles after the hydrothermal treatment of within a range of 800 to 1000° C. can be decreased (see Table 1). On the contrary, on using water solution of isopropanol 50% as a solvent and when the hydrothermal treatment is performed at not less than 150° C., the amount of decreasing the specific surface area of the alumina particles after the hydrothermal treatment of within a range of 800 to 1000° C. can be decreased.

Further, as shown in Table 3, it is possible to use the solvent of ethanol 50% and isopropanol 25% instead of the solvent of isopropanol 50% as shown in Table 1.

Still further, it is possible to use Alumina sol 520 manufactured by NISSAN CHEMICAL INDUSTRIES, LTD, similar to the case of the first embodiment, and to use ethanol 50% as the solvent instead of pure water.

As described above, it is possible to use the mixed solution water made of water and organic solvent such as ethanol and isopropanol as the solvent for dispersing the alumina particles therein. It is also possible to use organic solvent such as ethanol and isopropanol instead of the above mixed solution.

Although each solvent has a different vapor pressure corresponding to the temperature at which hydrothermal treatment is performed, it is possible to increase the thermal resistance of the alumina particles, like the case of the first embodiment.

As has not been shown in Table 3, as the method of producing the alumina particles from raw materials, there is a following manner, for example.

Solving aluminum nitride into a prescribed amount of pure water;

Adding co-precipitant such as ammonium or sodium hydroxide to the above solution;

Mixing the above solvent at room temperature for approximately 24 hours in order to obtain aluminum hydroxide as alumina precursor; and

Performing hydrothermal treatment to the aluminum hydroxide.
(3) In the first embodiment described above, in order to produce the catalyst support particles having the configuration shown in FIG. 1C by using the catalyst components 30 whose average particle size is not more than 10 nm, it is necessary for the alumina particles 20 to have the average particle size of not more than 40 nm, and the heating temperature in the hydrothermal treatment to γ-alumina particles is therefore set to within a range of 180 to 240° C., and the heating process is set to within a range of 1 to 3 hours.

On the contrary, it is possible to use the catalyst components 30 whose average particle size of not less than 10 nm. In this case, because the allowable maximum particle size of the alumina particles is increased, the upper limit of the heating temperature in the hydrothermal treatment becomes high. That is, the optimum condition of performing the hydrothermal treatment by the autoclave is changed according to the particle size of the catalyst components 30.
(4) In the method according to the first embodiment, the alumina particles as the support particles capable of supporting the catalyst components are gathered and solidity so that the alumina particles have the pore parts 22 and the penetration pore parts 23, where the size of the pore part 22 is larger than the size of the catalyst component 30 and the size of the penetration pore part 23 formed between adjacent alumina particles is smaller than the size of each catalyst component 30, as shown in FIG. 1A to FIG. 1C. However, it is not always necessary to gather the γ-alumina particles in order to form the penetration pore parts 23 whose size is smaller than the size of each catalyst component 30.
(5) In the method of producing the catalyzer according to the first embodiment of the present invention, the catalyst components produced are coated on the surface of the porous inorganic base material after the production of the catalyst support particles in which the catalyst components 30 are supported by the alumina particles 20. The concept of the present invention is not limited by this manner. It is therefore possible to form the catalyzer by using different manners.

For example, it is also acceptable to support the catalyst components by the alumina particles 20 after the layer made of the alumina particles is coated on the porous inorganic base material 10. In this manner, the alumina particles, which have been treated by the hydrothermal treatment by using the autoclave and dispersed in the liquid (as solvent), is coated on the surface of the porous inorganic base material 10. Then, the porous base inorganic material 10 with the alumina particles is dried and fired. Finally, the catalyst components dispersed in the liquid as solvent is applied to the surface of the porous inorganic base material 10, and then dried and fired in order to produce the catalyzer.

Because there is a possibility that the catalyst components do not always reach the inner part of the coated layer 21 composed of the alumina particles 20, it is preferred to use the method according to the first embodiment described above.
(6) The first embodiment has explained the method of producing the catalyst using the alumina particles as metal oxide particles capable of supporting the catalyst components. The present invention is not limited by the manner according to the first embodiment, for example, it is acceptable to use other metal oxide particles instead of the alumina particles. In general, the specific surface area of not only the alumina particle but also another oxide particle is reduced in the high temperature region approximately at 1000° C. Performing hydrothermal treatment to the metal oxide particles can enhance the heat resistance capability thereof. It is possible to use one or more kinds of compounds which are selected from metal oxide particles such as CeO₂, ZrO₂, TiO₂, SiO₂, MgO, and Y₂O₃.

In case of using various metal oxide particles other than the alumina particles, pH of a solution is firstly set to a specified value so that the surface voltage potential of the metal oxide particles in the solution becomes a voltage potential at which they can be dispersed in mono-dispersion state in the solution. The hydrothermal treatment is then performed for the metal oxide particles in the solution in the autoclave. Because it is only better to make the mono-dispersion state by electrically repulsing the particles to each other, it is acceptable to set the pH of the solution so that the surface voltage potential of the particles takes a negative value.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

1. A method of producing catalyst support particles in which catalyst components are supported on surfaces of metal oxide particles, comprising steps of:
preparing metal oxide particles dispersed in a liquid;
performing hydrothermal treatment under an applied pressure in the liquid so that thermal resistance of the metal oxide particles is increased while suppressing increase of a particle size of each metal oxide particle; and
supporting the catalyst components on the metal oxide particles treated by the hydrothermal treatment.

2. A method of producing catalyst support particles in which metal oxide particles support catalyst components, comprising steps of:
preparing metal oxide particles dispersed in a liquid;
performing hydrothermal treatment under an applied pressure in the liquid so that thermal resistance of the metal oxide particles is increased while suppressing increase of a particle size of each metal oxide particle under a condition capable of decreasing a specific surface area of each metal oxide particle after firing the metal oxide particles at 800° C., when compared with those of the metal oxide particles without performing the hydrothermal treatment; and
supporting the catalyst components on the metal oxide particles treated by the hydrothermal treatment.

3. The method according to claim 1, wherein the hydrothermal treatment is performed by setting the pH of the liquid to a specified value so that a surface voltage potential of the metal oxide particle in the liquid has a voltage potential at which the metal oxide particles are dispersed in a mono-dispersion state in the liquid.

4. The method according to claim 3, wherein one of, or a mixture of water, ethanol, and isopropanol is used as the liquid in the hydrothermal treatment.

5. The method according to claim 3, wherein the hydrothermal treatment is performed in the liquid to which aqueous polymer as a dispersion agent capable of dispersing the metal oxide particles is added, where the aqueous polymer is selected from one of, or a mixture of not less than two of polyvinyl alcohol, polyethylene glycol, polyvinyl pyrrolidone, and trehalose.

6. The method according to claim 3, wherein γ-alumina particles or alumina precursor particles are used as the metal oxide particles.

7. The method according to claim 6, wherein the hydrothermal treatment is performed in the liquid whose pH is within a range of 2 to 4.

8. The method according to claim 7, wherein the hydrothermal treatment is performed under the condition in which the γ-alumina particles or the alumina precursor particles are dispersed in water at a heating temperature of not less than 180° C. and not more than a temperature of suppressing cohesion of those particles to each other under an applied pressure corresponding to the heating temperature.

9. The method according to claim 8, wherein the heating temperature in hydrothermal treatment is not more than 240° C.

10. The method according to claim 9, wherein the heating temperature in hydrothermal treatment is set to a temperature capable of decreasing occurrence of the phase transition of the alumina particles from γ-phase to θ-phase.

11. The method according to claim 10, wherein the hydrothermal treatment is performed under the condition so that the θ-phase crystals of the alumina particles are obtained by firing them at 800° C. after performing the hydrothermal treatment.

12. The method according to claim 11, wherein the hydrothermal treatment is performed at 220° C. for 3 hours or at 240° C. for a period within a range of not less than 1 hour and not more than 3 hours.

13. The method according to claim 1, wherein when the metal oxide particles treated by the hydrothermal treatment support the catalyst components, the metal oxide particles are cohesively gathered to each other so that pore parts whose size is larger than the size of each catalyst component, penetrate pore parts whose size is smaller than the size of each catalyst component are generated in the cohesive metal oxide particles, and the catalyst components are placed in the pore parts in order to fix the catalyst components to the metal oxide particles.

14. The method according to claim 13, wherein when the metal oxide particles treated by the hydrothermal treatment support the catalyst components, the following steps are performed:
producing a mixed solution composed of the metal oxide particles and the catalyst components by adding the catalyst components into the metal oxide particles dispersed in the liquid after performing the hydrothermal treatment to the metal oxide particles;
producing a mixture powder composed of the metal oxide particles cohesively gathered through the pore parts and the penetrate pore parts and the catalyst components placed in the pore parts by drying the mixed solution; and
producing the catalyst support particles in which the metal oxide particles are fixed to each other and the metal oxide particles and the catalyst components are fixed to each other by firing the mixture powder.

15. The method according to claim 1, wherein when the metal oxide particles treated by the hydrothermal treatment support the catalyst components, catalyst particles are used as the catalyst components, each of which is composed of a base particle and a surface coating layer covering at least a part of the base particle, wherein the base particle is composed of one kind of mono fine particle or solid solution fine particles composed of two or more kinds of the mono fine particle having a primary particle size of a nanometer order, and the surface coating layer is made of one or more kinds of metals or derivatives thereof.

16. The method according to claim 15, wherein the base particle as the catalyst components is made of one of metal oxide, metal carbide, and carbon material.

17. The method according to claim 16, wherein the catalyst particles are used as the catalyst components, in each of which the base particle is made of a mono-material selected from metal oxides of Ce, Zr, Al, Ti, Si, Mg, W and Sr and derivatives thereof, or of a solid solution composed of two or more those mono-materials.

18. The method according to claim 15, wherein each catalyst particle as the catalyst components has the surface covering layer composed of ultra-fine particle, whose particle size is less than 50 nm.

19. The method according to claim 15, wherein each catalyst particle as the catalyst components has the surface coating layer composed of not less than one kind of, or a solid solution composed of two or more kinds of Pt, Rh, Pd, Au, Ag and Ru and oxides thereof.

20. A method of producing a catalyzer comprising steps of:
preparing the catalyst support particles produced by the method of claim 1 and a porous inorganic base material;
making a dispersion liquid by dispersing the catalyst support particles in a liquid;
applying the dispersion liquid on a surface of the porous inorganic base material; and
drying and firing the porous inorganic base material in order to produce the catalyzer in which a coated layer composed of the catalyst support particles is formed on the surface of the porous inorganic base material.
